(19) United States
(12) Patent Application Publication
(10) Pub. No.: US 2015/0312052 A1
(43) Pub. Date: Oct. 29, 2015

(54) user station of a bus system and method for transmitting messages between user stations of a bus system

(71) Applicants: Christian HORST, Dusslingen (DE); Florian HARTWICH, Reutlingen (DE)

(72) Inventors: Christian HORST, Dusslingen (DE); Florian HARTWICH, Reutlingen (DE)

(21) Appl. No.: 14/367,395

(22) PCT Filed: Dec. 20, 2012
(86) PCT No.: PCT/EP2012/076299

§ 371 Date: Jun. 20, 2014

(30) Foreign Application Priority Data
Dec. 22, 2011 (DE) 10 2011 089 587.6

(51) Int. Cl. H04L 12/40; G06F 13/42

(52) U.S. Cl. CPC H04L 12/40169; G06F 13/4208; H04L 2012/40215

(57) ABSTRACT

An user station of a bus system and a method for transmitting messages between user stations of a bus system are provided. The user station includes a comparator device for comparing an identifier of a received message to a preconfigured transmission identifier of a transmission memory of the user station.

### FIELD OF THE INVENTION

The present invention relates to a user station of a bus system and a method for transmitting messages between user stations of a bus system, in which, in particular, sending conflicts are able to be detected independently by a user station.

### BACKGROUND INFORMATION

A bus system is understood at present, in which messages are transmitted using CAN protocols, as described in the CAN Specification in ISO11898.

German document DE 100 00 305 A1 discusses the CAN (Controller Area Network=Steuereinrichtungsnetzwerk in German) as well as an elaboration of it designated as TTCAN (Time Triggered CAN=Zeit getriggertes CAN in German).

CAN and TTCAN work with a message-based protocol and are used in vehicles, for example. A bus system based on CAN or TTCAN enables all user stations connected to it, such as microcontrollers, to communicate with one another.

Since all user stations of the CAN bus wish to access the CAN bus for sending messages, the authorization to send messages has to be distributed as impartially as possible or in accordance with a predetermined system. This distribution, called arbitration, takes place on the CAN bus bit-by-bit by sending an identification code, which is also called an identifier. Each identifier stands for a certain priority of the message designated by it or the transmitting user station as the sender. The higher the priority of the message, the more dominant bits are added by the sender of the message as identifier. The lower the priority, the more the recessive bits that are added. The important point is that a dominant bit of a sender overwrites recessive bits compared with this from competing senders. Because of this, all messages graded as more important have priority over messages graded as less important.

Therefore, each sender, that is, each user station, observes the bus working according to the CAN protocol over its input, while the sender sends data over its own transmission output, the Tx output. If the sender ascertains that a dominant bit has appeared on the bus, while he himself is sending a message having a recessive bit, the sender changes from a transmitting operation to a receiving operation. This method of the bit-by-bit, nondestructive arbitration makes certain that, at the latest at the end of the identification code in a message, only one transmitting user station is still on the bus, whereas all the other user stations are receivers.

In such a method, it is assumed, however, that each user station connected to the CAN bus is configured as a sender for another identification code. For, if two user stations send a message at the same time having the same identification code, in the present method, both user stations continue to transmit at the end of the arbitration. Because of that, the destruction of their messages will take place on the bus, by the overwriting of recessive bits. This leads to the loss of data.

In addition, in the configuration of a CAN bus, many reconciliations are required, and therefore effortful documentation, so that all user stations of a CAN bus are configured having different identification codes. If the CAN bus is later to be extended by an additional user station, the determination of its identification code as sender becomes even more effortful or very difficult. Therefore, a design approach is required which does away with these problems.

### SUMMARY OF THE INVENTION

It is therefore an object of the present invention to provide a user station of a bus system and a method for transmitting data between user stations of a bus system, which solve the problem mentioned above, and, in particular, make possible that no data loss is created when more than one user station in a CAN bus system sends out messages having one identifier, using which another user station of the CAN bus system is also sending out messages.

The object is attained by a user station of a bus system having the features described herein. The user station includes a comparator device for comparing an identifier of a received message to a preconfigured transmission identifier of a transmission memory of the user station.

The user station described is able to detect independently whether another user station in the bus system is sending out messages having an identifier, with which the other user stations also have to send out messages. In this way, message collisions in the bus system are able to be prevented effectively in a simple manner.

The user station is able to prevent messages sent by it from getting lost. In addition, the user station is able to prevent messages sent by it from destroying the messages of other user stations using the same identifier, i.e. the same priority.

In the case of the user station described, the configuration of user stations for a CAN bus system may be clearly simplified. In addition, it is possible to extend an existing bus system without great effort with regard to costs and time.

Advantageous further embodiments of the user station are specified in the further descriptions herein.

It is possible for the user station to be equipped additionally with a blocking device, for blocking a transmission memory of the user station, if the result of the comparison of the comparator device yields that the identifier of the message received is identical to the transmission identifier preconfigured for the transmission memory.

It is also possible that the user station additionally has a flag setting device for setting a collision flag, in order to signal that, in the bus system, the preconfigured identifier of a transmission memory of the user station has been assigned several times over, if the result of the comparison of the comparator device yields that the identifier of the message received is identical to the transmission identifier preconfigured for the transmission memory.

The user station may have a comparator device which is configured so that it undertakes the comparison of the identifiers only for a message received free from error.

The user station may have a comparator device which, in addition, is embodied for the comparison of the identifier of a received message to a preconfigured receiving filter of a receiving memory of the user station.

The user station described above may be a part of a bus system for transmitting data between user stations, which has at least one such user station described before.

The object stated before is additionally attained by a method for transmitting messages between user stations of a bus system having the features described herein. The method has the task of: Comparing, using a comparator device, an identifier of a received message received having a preconfigured transmission identifier of a transmission memory of the user station.

Using this method, the same advantages may be achieved which were named above, with reference to the user station.

Advantageous further embodiments of the method are specified in the further descriptions herein.

The method advantageously also includes the task of blocking a transmission memory of the user station, if the result of the comparison of the comparator device yields that the identifier of the message received is identical to the transmission identifier preconfigured for the transmission memory.

It is of advantage that the method additionally has a task of setting a collision flag, in order to signal that, in the bus system, the preconfigured identifier of a transmission memory of the user station has been assigned several times over, if the result of the comparison of the comparator device yields that the identifier of the message received is identical to the transmission identifier preconfigured for the transmission memory.

The task of comparing may include a comparison of the identifier of a message received to a preconfigured receiving filter of a receiving filter of a receiving memory of the user station and/or may be carried out only for a message received free from error.

Additional possible implementations of the present invention also include combinations of features or specific embodiments not explicitly mentioned above or below with regard to the exemplary embodiments. In this context, one skilled in the art will also add individual aspects as improvements or supplementations to the respective basic form of the present invention.

In the following text, the present invention is explained in greater detail with reference to the appended drawings, with the aid of an exemplary embodiment.

Unless indicated otherwise, identical or functionally corresponding elements have been provided with the same reference numerals.

### BRIEF DESCRIPTION OF THE DRAWINGS

FIG. 1 shows an overview block wiring diagram of a bus system according to the exemplary embodiment.

FIG. 2 shows a simplified view of a design of a message transmitted over the bus system according to the exemplary embodiment.

FIG. 3 shows a detailed block wiring diagram of a part of the user station according to the exemplary embodiment.

FIG. 4 shows a flow chart of a method according to the exemplary embodiment.

### DETAILED DESCRIPTION

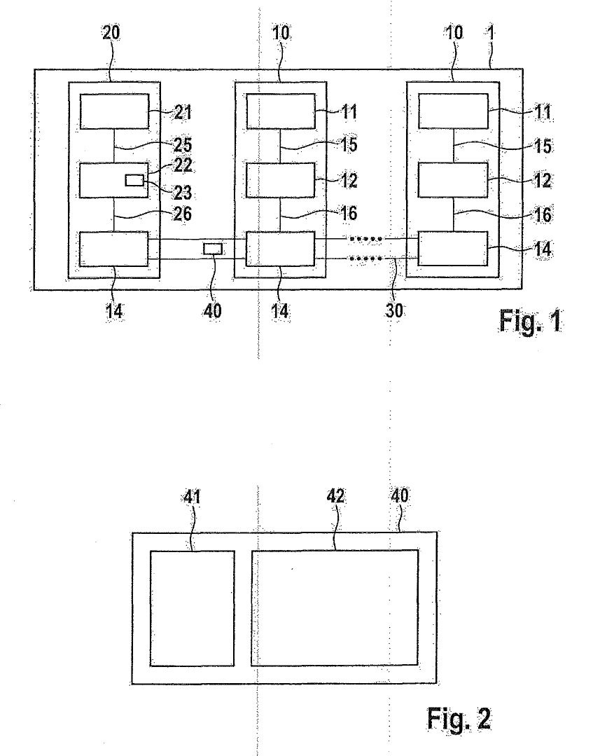

FIG. 1 shows a bus system which may be a CAN bus system, for example, which may be used in a vehicle, etc., or in a hospital, etc. Bus system 1 has two first user stations 10, a second user station 20 and a bus 30, to which the first and second user station 10, 20 are connected and via which first and second user stations 10, 20 are able to send and receive messages 40.

In FIG. 1, the first user stations 10 each have a microcomputer 11, a CAN control device 12, which will be called CAN controller 12 from here on, and a CAN send/receive device 14, which will be called CAN transceiver 14 from here on. Microcomputer 11 is connected via a connection 15 to CAN controller 12. CAN controller 12 is connected to CAN transceiver 14 via a connection 16. Data may be exchanged between microcomputer 11, CAN controller 12 and CAN transceiver 14 via connections 15, 16. The data may be messages 40 and/or configuration data, control data and status data to be transmitted via user system 1, or rather bus 30.

In addition, in FIG. 1, second user stations 20 in each case has a microcomputer 21, a CAN control device 22, which will be called CAN controller 22 from here on, having a comparator device 23, and a CAN send/receive device 24 which will be called CAN transceiver 24 from here on. Microcomputer 21 is connected via a connection 25 to CAN controller 22. Furthermore, CAN controller 22 is connected via a connection 26 to a CAN transceiver 24. Connections 25, 26 have the same functions in second user station 20 as connections 15, 16 have in first user station 10.

As may be seen in FIG. 1, only second user station 20 has a comparator device 23. First user stations 10 are thus able to represent a user station that was already previously present in bus system 1. By contrast, second user station 20 is able to represent a user station by which bus system 1 has been extended later.

In a greatly simplified manner, FIG. 2 represents the design of a message 40, as sent via bus 30 by one of user stations 10, 20. Message 40 has an identifier 41 and other contents 42, which are not designated in greater detail at this point. The other contents include all the contents which a message 40 has, according to the CAN protocol. Before identifier 41, a start bit is normally still present in message 40 which has been omitted in FIG. 2, however, for the sake of simplicity, and in this case also belongs to other contents 42. Identifier 41 is added to message 40 by the respective user station 10, 20 before message 40 is sent out by CAN transceiver 14, 24 of the respective user station 10, 20 via bus 30.

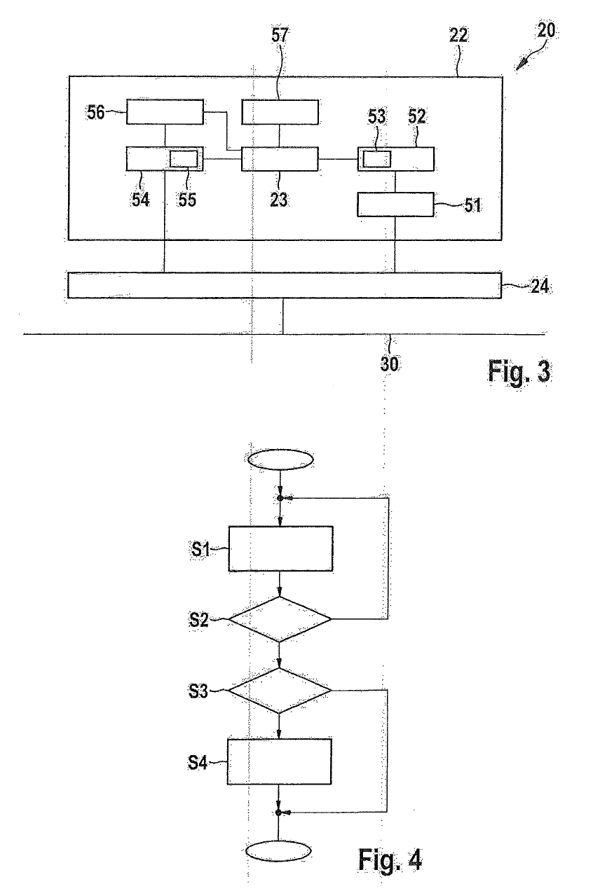

FIG. 3 shows the design of CAN controller 22, having comparator device 23 and together with CAN transceiver 14, more accurately. Besides comparator device 23, CAN controller 22 has a receiving filter 51, a receiving memory 52 having a preconfigured receiving identifier 53, a transmission memory 54 having a preconfigured transmission identifier 55, a blocking device 56 and a flag setting device 57.

In FIG. 3, receiving filter 51 is used for filtering messages 40 received by CAN transceiver 14, according to preconfigured reception criteria. In this connection, receiving identifier 53 of receiving memory 52 is taken into account. Only messages 40 are received and stored in receiving memory 52 whose identifier 41 is identical to receiving identifier 53. Receiving memory 52 may be a FIFO memory, which works according to the known principle of FIFO (first in first out), messages 40 first stored in receiving memory 52 also being read out first from receiving memory 52.

Transmission memory 54 in FIG. 3 sends out messages having preconfigured transmitting identifier 55. In reference to transmission memory 54, user station 20 (FIG. 1), or more accurately put, its CAN controller 22, is prepared in such a way that its comparator device 23, after receiving an error-free message 40, compares identifier 41 of message 40 to the preconfigured transmission identifier 55 of transmission memory 54. Depending on the result of this comparison of comparator device 23, blocking device 56 blocks, or does not block transmission memory 54. In addition, flag setting device 57 sets a collision flag, in order to signal that in bus system 1 the preconfigured transmission identifier 55 of transmission memory 54 of user station 20 has been assigned several times over. This sequence is illustrated more accurately in FIG. 4.

FIG. 4 shows the method carried out by CAN controller 22, or stated more accurately, its comparator device 23, if user station 20 receives an error-free message 40. After the start of the method, at a step S1, a message 40 is received by CAN transceiver 24 and passed on to CAN controller 22 via connection 26. After that, the flow continues to a step S2.

At step S2, CAN controller 22 checks whether message 40 has been received error-free or not. If the response at step S2 is NO, the sequence reverts to step S1.

However, if the response at step S2 is YES, the flow continues to step S3.

At step S3, it is checked, using comparator device 23, whether identifier 41 of message 40, received error-free, is identical to transmission identifier 55 in transmission memory 54 of CAN controller 22, or not. If the response at step S3 is NO, the method is ended.

However, if the response at step S3 is YES, the flow continues to step S3.

At step S4, transmission memory 54, which is configured with transmission identifier 55, is blocked for sending, using blocking device 56. In addition, flag setting device 57 sets a flag, the collision flag, which signals the conflict that has occurred by an error message to user station 20. Subsequently the method is ended. Based on the error message, a service technician, for example, is able to configure transmission memory 54 using another transmission identifier 55, in order to remove the error.

In this way it is avoided that a sending conflict will occur between two user stations 10, 20 in bus 30. For, because of this, two messages 50 having the same identifier 41 are never transmitted on bus 30 at the same time.

All the embodiments of second user station 20 and the method described before may be used individually or in all possible combinations. In addition, the following modifications are particularly conceivable.

Bus system 1 described before is described with the aid of bus system 1 based on the CAN protocol. However, bus system 1 may also be another type of communications network. It is advantageous, but not an unavoidable presupposition, that in bus system 1, at least for certain time periods, exclusive, collision-free access by a user station 10, 20 to a common channel is ensured.

Bus system 1 according to the exemplary embodiment is a CAN network, in particular, or a TTCAN network or a CAN FD network.

The number of first and second user stations 10, 20 in bus system 1 is optional. More or fewer than two first user stations 10 may be present in bus system 1. In addition, more than one second user station 20 may also be present in bus system 1. In particular, only second user stations 20 may also be present in bus system 1.

Second user station 20 may have more than one receiving memory 52. In addition, second user station 20 may have more than one transmission memory 54. Consequently, comparator device 23 is able to carry out the comparison of identifiers 41, 53, 55 for all receiving memories and transmission memories.

Step S4 of the method may also include only the task of comparing. It may be the case, however, step S4, besides the task of comparing, also has the task of setting the collision flag, since then an error message is visible to a service technician. In this case, the task of blocking transmission memory 54 does not have to be included.

1-10. (canceled)

11. A user station of a bus system, comprising:
a comparator device for comparing an identifier of a received message to a preconfigured transmission identifier of a transmission memory of the user station.

12. The user station of claim 11, further comprising:
a blocking device for blocking a transmission memory of the user station, if the result of the comparison of the comparator device yields that the identifier of the received message is identical to the transmission identifier preconfigured for the transmission memory.

13. The user station of claim 11, further comprising:
a flag setting device for setting a collision flag, to signal that, in the bus system, the preconfigured identifier of a transmission memory of the user station has been assigned several times over, if the result of the comparison of the comparator device yields that the identifier of the received message is identical to the transmission identifier preconfigured for the transmission memory.

14. The user station of claim 11, wherein the comparator device is configured so that it undertakes the comparison of the identifier only for a message that is received error-free.

15. The user station of claim 11, wherein the comparator device is configured for comparing the identifier of a received message to a preconfigured receiving filter of a receiving memory of the user station.

16. A bus system for transmitting data between user stations, comprising:
at least one user station, including a comparator device for comparing an identifier of a received message to a preconfigured transmission identifier of a transmission memory of the user station.

17. A method for transmitting messages between user stations of a bus system, the method comprising:
comparing, using a comparator device, an identifier of a received message to a preconfigured transmission identifier of a transmission memory of the user station.

18. The method of claim 17, further comprising:
blocking a transmission memory of the user station, if the result of the comparison of the comparator device yields that the identifier of the received message is identical to the transmission identifier preconfigured for the transmission memory.

19. The method of claim 17, further comprising:
setting a collision flag, to signal that, in the bus system, the preconfigured identifier of a transmission memory of the user station has been assigned several times over, if the result of the comparison of the comparator device yields that the identifier of the received message is identical to the transmission identifier preconfigured for the transmission memory.

20. The method of claim 17, wherein the comparing includes a comparison of the identifier of a received message to a preconfigured receiving filter of a receiving memory of the user station and/or is carried out only for a message received free from error.
